(19) United States
(12) Patent Application Publication
(10) Pub. No.: US 2017/0220649 A1
(43) Pub. Date: Aug. 3, 2017

(54) SYSTEM, METHOD, AND NON-TRANSITORY COMPUTER-READABLE STORAGE MEDIA FOR EVALUATING SEARCH RESULTS IN A CUSTOMER QUEUEING SYSTEM

(71) Applicant: Wal-Mart Stores, Inc., Bentonville, AR (US)

(72) Inventor: Justin Toupin, San Francisco, CA (US)

(21) Appl. No.: 15/009,644

(22) Filed: Jan. 28, 2016

(51) Int. Cl. G06F 17/30; H04W 4/20; G06Q 30/02; H04W 4/02

(52) U.S. Cl. CPC G06F 17/30554; H04W 4/021; H04W 4/20; G06F 17/30477; G06Q 30/0281

(57) ABSTRACT

Systems, methods, and computer-readable storage media are provided that perform a search request against a queue database of customers in a queue for access to a resource.

### FIELD OF THE DISCLOSURE

The present invention relates to search engines, and more particularly, to systems, methods, and computer-readable storage media that perform a search request against a queue database of customers in a queue for access to a resource. The suggested class/subclass of the disclosure is: CLASS 707/722 (DATA PROCESSING: DATABASE, DATA MINING, AND FILE MANAGEMENT OR DATA STRUCTURES/Post processing of search results) and the suggested Art Unit is 2161.

### BACKGROUND

Generally, retail establishments currently allow a customer to shop for items or goods, place the items in a cart or basket, check-out and pay for items by using a traditional cashier who scans each item and then receives tender from the customer for payment of the items. When the retail establishment is busy, the lines in the check-out lines may be quite long, requiring the customer to stand in a line for a long period of time.

Some retail establishments will, at different times, have customer lines for other reasons. For example, a retail establishment may experience long lines at the pharmacy, the delicatessen, or at a service station, such as customer service or at an auto repair or service facility. Other resources that may experience long lines include customer lines to purchase an on-sale item such as on a special sale day, e.g., Black Friday.

Having customers stand in lines can be a frustrating experience for the shoppers, leading to an unenjoyable experience. The present invention is aimed at one or more of the problems identified above.

### SUMMARY OF THE INVENTION

In different embodiments of the present invention, systems, methods, and computer-readable storage media allow customers to utilize a mobile device, such as a cell phone, to establish a position within a queue at a retail store or environment.

In one embodiment, a system having a database, a customer control unit, a queue module, a request device, a search engine module and a notification module is provided. The database includes a list of customers. The list of customers defines a queue for access to a resource. The customer control unit is associated with a customer. The customer control unit is configured to receive a request from the customer to be added to the queue and to generate a request signal. The queue module is configured to receive the request signal, to assign the customer a number in the queue, and to store the queue number assigned to the customer at the bottom of the list in the database. The request device is configured to receive input and to generate a search engine request for a first customer in the queue. The search engine module is coupled to the database and the request device and is configured to receive the search engine request, to access the database, to establish the first customer from the list of customers as a function of the search engine request, and to return the queue number associated with the next customer. The notification module is coupled to the search engine module and the customer control unit and is configured to receive the queue number associated with the next customer and to send a message to the customer control unit to inform the customer of a relative position in the queue.

In other embodiments, a method includes the step of maintaining, in a database, a list of customers. The list of customers defines a queue for access to a resource. The method also includes the steps receiving a request to add the customer to the queue, assigning the customer a number in the queue, and storing the queue number assigned to the customer at the bottom of the list in the database. The method further includes the steps of receiving an input at a request device and generating a search engine request for a first customer in the queue, accessing the database to establish the first customer from the list of customers as a function of the search engine request, and returning the queue number associated with the next customer. The method also includes the steps of receiving the queue number at a notification module coupled to the search engine module and the customer control unit and responsively sending a message to the customer control unit to inform the customer of a relative position in the queue.

In still other embodiments, one or more non-transitory computer-readable storage media, have computer-executable instructions embodied thereon. When executed by at least one processor, the computer-executable instructions cause the at least one processor to maintain a database including a list of customers. The list of customers defines a queue for access to a resource. A request to add the customer to the queue is received at a customer control unit and a request signal is generated. The request signal is received at a queue module, the customer is assigned a number in the queue, and the queue number is assigned to the customer at the bottom of the list in the database. An input is received at a request device and a search engine request for a first customer in the queue is generated. The search engine request is received at a search engine module coupled to the database and the input device, the database is accessed to establish the first customer from the list of customers as a function of the search engine request, and the queue number associated with the next customer is returned. The queue number is received at a notification module coupled to the search engine module and the customer control unit and a message is responsively sent to the customer control unit to inform the customer of a relative position in the queue.

### BRIEF DESCRIPTION OF THE FIGURES

Other advantages of the present disclosure will be readily appreciated, as the same becomes better understood by reference to the following detailed description when considered in connection with the accompanying drawings wherein:

Non-limiting and non-exhaustive embodiments of the present invention are described with reference to the following figures, wherein like reference numerals refer to like parts throughout the various views unless otherwise specified.

FIG. 1 is a diagrammatic illustration of a system for use in a retail transaction according to the present invention;

FIG. 2 is a schematic illustrating example components of a server, according to an embodiment of the present invention;

FIG. 3 depicts a block schematic diagram of an exemplary computing system, in accordance with one embodiment of the present invention;

FIG. 4 is a diagrammatic illustration of a mobile device operating in a system, according to an embodiment of the present invention;

FIG. 5 is a block schematic diagram of a queuing system, according to an embodiment of the present invention;

FIG. 6 is a flow diagram of a method for operating a queuing system, according to an embodiment of the present invention;

FIG. 7 is an exemplary screenshot from a mobile during operation of the queuing system, according to an embodiment of the present invention;

FIG. 8 is an exemplary screenshot from a mobile during operation of the queuing system, according to an embodiment of the present invention;

FIG. 9 is an exemplary screenshot from a mobile during operation of the queuing system, according to an embodiment of the present invention;

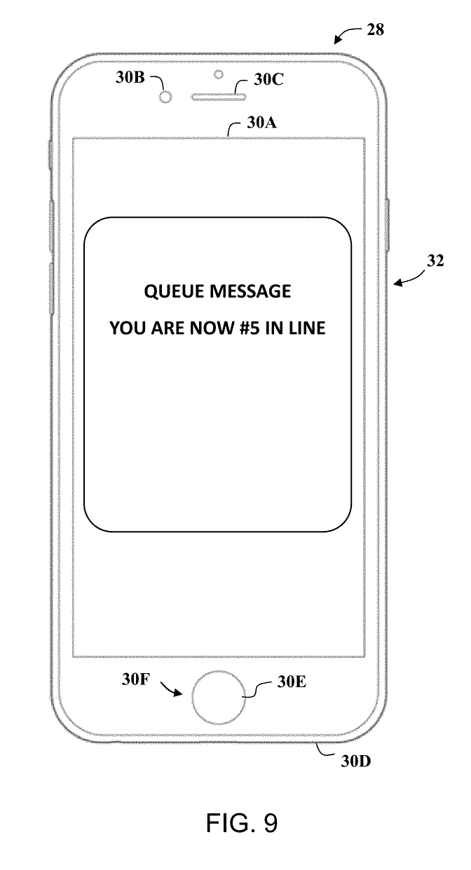

FIG. 10 is an exemplary screenshot from a mobile during operation of the queuing system, according to an embodiment of the present invention; and,

FIG. 11 is an exemplary screenshot from a mobile during operation of the queuing system, according to an embodiment of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module”, “unit”, or “system.” Furthermore, the present invention may take the form of a computer program product embodied in any tangible media of expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis.

The disclosure particularly describes how a customer may order or select and purchase goods and use a queue system. With reference to the FIGS. and in operation, in one aspect of the present invention provides a retail process system 10. The system 10 may include components, methods and computer product media that maintain and administer a virtual queue system 12. Other features of the system 10 can be found in the following commonly owned US patent applications, which are hereby incorporated by reference: US patent application Serial Number N/A, filed on Jan. 28, 2016 (Attorney Docket Number 068571.00242); US patent application Serial Number N/A, filed on Jan. 28, 2016 (Attorney Docket Number 068571.00243); US patent application Serial Number N/A, filed on Jan. 28, 2016 (Attorney Docket Number 068571.00244); US patent application Serial Number N/A, filed on Jan. 28, 2016 (Attorney Docket Number 068571.00245); US patent application Serial Number N/A, filed on Jan. 28, 2016 (Attorney Docket Number 068571.00246); US patent application Serial Number N/A, filed on Jan. 28, 2016 (Attorney Docket Number 068571.00247); US patent application Serial Number N/A, filed on Jan. 28, 2016 (Attorney Docket Number 068571.00248); US patent application Serial Number N/A, filed on Jan. 28, 2016 (Attorney Docket Number 068571.00249); US patent application Serial Number N/A, filed on Jan. 28, 2016 (Attorney Docket Number 068571.00250); US patent application Serial Number N/A, filed on Jan. 28, 2016 (Attorney Docket Number 068571.00251); and US patent application Serial Number N/A, filed on Jan. 28, 2016 (Attorney Docket Number 068571.00252).

The system 10 may also facilitate the order and/or tendering of payment of an order for a customer. The order may have been placed on-line, remotely or may have been assembled by the customer at a retail environment 6. The retail environment 6 may be a retail store, a specified location at which the customer may pick-up of the order, and/or a delivery vehicle that delivers an assembled order to the customer.

The virtual queue system 12 may include a queue computer 16 and may access one or more databases 8. The database 8 may be stored on the queue computer 12 or may be stored remotely (and combined with database(s) 20) and accessed through one or more server(s) 18. The virtual queue system 12 may be a stand-alone system or more be integrated and share one or more components with other systems in the retail process system 12.

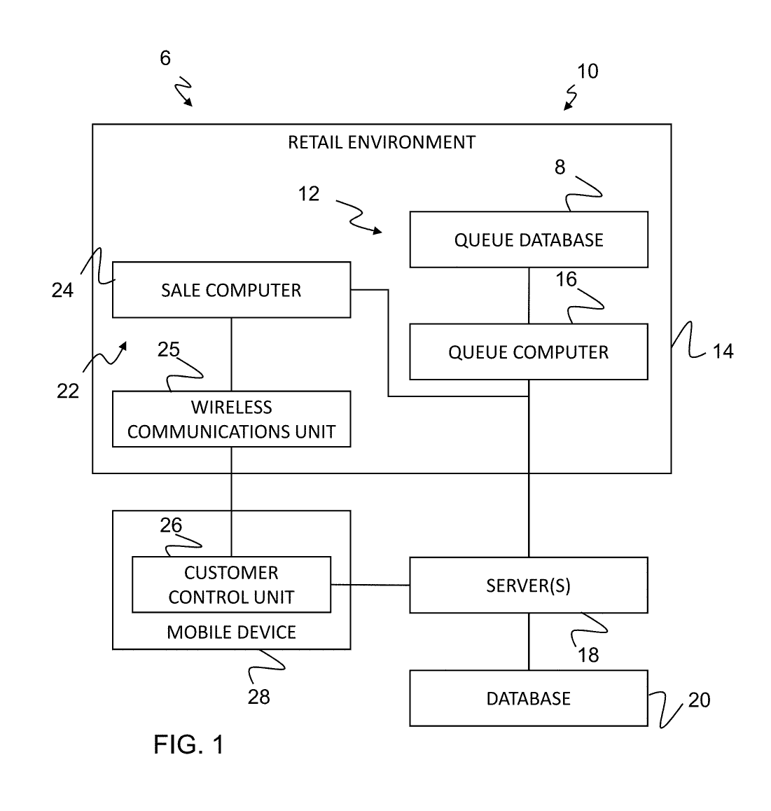

Referring to FIG. 1, a high-level exemplary environment 20 in which the system 10 operates is illustrated. A customer may desire to purchase items from a facility or retail store at a specified location, such as a store. The store may be representative of a larger corporate environment which may provide many avenues of interface with a customer. In a modern shopping environment, a store may include both one or more brick and mortar retail locations and an on-line retail location. In some situations, a customer may not desire to go to the store or may not have sufficient time to go to the store.

Alternatively, the customer may desire that the order be delivered to their home location, business location, or some other location. In situations, the retail environment 6 may be the delivery vehicle or centered about the delivery vehicle.

With reference to FIG. 1, the system 10 includes a sale computer system 22 to facilitate the processing of the customer order. In one embodiment, the sale computer system 22 may be a stand-alone computer that is located at the retail environment 6. Alternatively, the sale computer system 22 may include a sale computer 24 located at the retail environment 6 and one or more servers 18 which is generally located remotely. The database 18 may be used to store customer account information, customer order information, and information related to the retail environment 6 (see below). The sale computer system 12 or the server 16 may access the data stored on the database 18. For example, the database 18 may include a plurality of customer accounts. Each customer account has an associated customer identification, e.g., an identification number. The sale computer 24 may access the customer accounts to running a query against the database based on customer identification number.

In some embodiments, a customer control unit 26 communicates with the sale computer 24 with a wireless communications unit 25. The wireless communications unit 25 may be, e.g., a wireless router or wireless access point that provides a wireless network (wireless network or Wi-Fi). In general, the customer control unit 26 is embodied in a software application or “app” that is run by the mobile device 28. As discussed further below, the customer control unit 26 may also be used in the virtual queue system 12.

The mobile device 28 may be the customer's cell phone. In some embodiments, the mobile device 28 may communicate with the sale computer system 24 (or the server 18) over the cellular data network. A system that facilitates the processing of customer orders is disclosed in commonly owned U.S. patent application Ser. No. 15/004,624, filed on Jan. 22, 2016, which is hereby incorporated by reference.

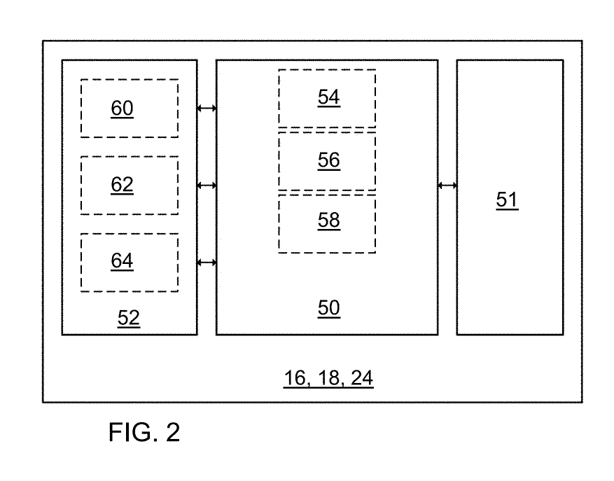

As referenced above, the server 18, the sale computer 24 and the queue computer 16 may be combined into a single computer or server 16, 18, 24. Alternatively, the functions of the server 18, sale computer 24, and the queue computer 16 may be distributed among multiple computers or servers, 16, 18, 24. The server(s) or computer(s) 16, 18, 24 may be configured to perform one or more functions associated with receiving an order from a customer, managing the delivery or pick-up of the customer orders, streamlining the collection of items for customer orders and/or managing one or more queues or lists. FIG. 2 illustrates an example of the server or computer(s) 16, 18, 24 configured to perform one or more of the requested functions. In the illustrated embodiment, the server or computer(s) 16, 18, 24 may include a processing device 50, a communication device 51, and a memory device 52.

The processing device 50 can include memory, e.g., read only memory (ROM) and random access memory (RAM), storing processor-executable instructions and one or more processors that execute the processor-executable instructions. In embodiments where the processing device 90 includes two or more processors, the processors can operate in a parallel or distributed manner. In an example, the processing device 50 may execute a web or application module 54, a delivery module 56, and an order fulfillment module 58.

The communication device 51 is a device that allows the first server 24 to communicate with another device, e.g., the customer device 28, delivery service computer 34, etc. The communication device 51 can include one or more wireless transceivers for performing wireless communication and/or one or more communication ports for performing wired communication.

The memory device 52 is a device that stores data generated or received by the first server 24. The memory device 52 can include, but is not limited to a hard disc drive, an optical disc drive, and/or a flash memory drive. Further, the memory device 52 may be distributed and located at multiple locations. The memory device 52 is accessible to the processing device 90. In some embodiments, the memory device 94 stores a customer database 60, an item database 62, and a delivery database 64.

In some examples, the customer database 60 can store information associated with a customer. The customer database 60 may, for example, store information associated with a customer account and may include account preferences and customer contact information. The customer database 60 may also store information regarding a customer delivery address as well as specific details regarding delivery of items to the delivery address. The customer database 60 may be queried by the processing device 50 and may provide information to the processing device to facilitate receiving an order from a customer and delivering an order to the customer.

In some examples, the item database 62 stores item information associated with items or types of items in the store 20. For example, the item database 62 may store identification codes, UPC codes, item location in the store 20, as well as other information associated with the items. By way of example, the item database 62 may be queried by the processing device 50 and may transmit information to the processing device to facilitate the use of item data.

In some examples, the delivery database 64 stores information to facilitate delivery of customer orders to a customer location 22. The delivery database 64 may store information regarding a map of a delivery area or an area around a store 20, street and traffic information for a delivery area, delivery routes, and transit times associated with a delivery area, etc.

The processing device 50 may execute the web or application module 54. The web or application module 54 may present a store interface and item information to a customer, receive customer information and order information, and otherwise handle the purchase transaction with a customer as described herein. The processing device 50 may also execute a delivery module 56. The delivery module may receive customer delivery address information from the web or application module 54 and may determine customer location, compare location with existing delivery routes, determine available delivery times, schedule deliveries, create delivery routes, and otherwise manage delivery of customer orders. The web or application module 54 may receive potential delivery times from the delivery module 56 and present these potential delivery times to a customer to allow the customer to select a delivery window for their order. The processing device 50 may further close orders for a delivery route, finalize the delivery route, and interface with a delivery service 32 to deliver orders to customers.

The processing device 50 may execute an order fulfillment module 58. The order fulfillment module 58 may receive customer order information for a delivery route and may facilitate the collection of items from a store to fulfill the customer orders. The order fulfillment module 58 may combine orders together, arrange items according to a predetermined picking order through a store 20, and direct a store employee through the store 20 to collect items for the customer orders.

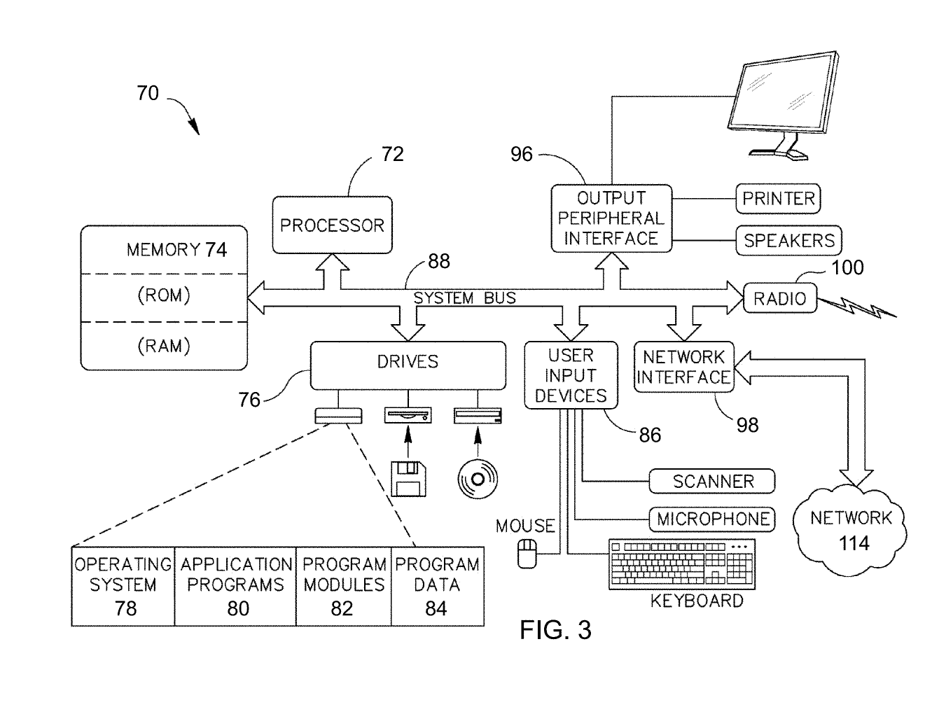

FIG. 3 includes a computer 70, which could be any one of a mobile device 28 or computer or server 16, 18, 24. Computer 70 may be a portable device, wherein at least some or all of its components are formed together in a single device which can be carried around by a person. The computer 70 includes a processor 72, memory 74 and one or more drives 76 such as a solid stake drive or SSD. The drives 76 and their associated computer readable memory medium provide storage of computer readable instructions, data structures, program modules and other data for the computer 70. Drives 76 can include an operating system 78, application programs 80, program modules 82, and program data 84. Computer 70 further includes input devices 86 through which data may enter the computer 70, either automatically or by a user who enters commands and data. Input devices 86 can include an electronic digitizer, a flatbed scanner, a barcode reader, a microphone, a camera, a video camera, a keyboard and a pointing device, commonly referred to as a mouse, a trackball or a touch pad, a pinpad, any USB device, any Bluetooth enabled device, an RFID or NFC device, and a debit card reader. Other input devices may include a joystick, game pad, satellite dish, scanner, touchscreen and the like. In one or more embodiments, input devices 86 are portable devices that can direct display or instantiation of applications running on processor 72.

These and other input devices 86 can be connected to processor 72 through a user input interface that is coupled to a system bus 88, but may be connected by other interface and bus structures, such as a parallel port, game port or a universal serial bus (USB). Computers such as computer 70 may also include other peripheral output devices such as speakers, printers, and/or display devices, which may be connected through an output peripheral interface and the like.

Computer 70 also includes one or more radios 100 or other type of communications device for wirelessly transmitting and receiving data for the computer 70 with the aid of an antenna. Radio 100 may wirelessly transmit and receive data using WiMAX™, 842.11a/b/g/n, Bluetooth (e.g., BLE), 2.5G, 3G, and 4G, wireless standards.

Computer 70 may operate in a networked environment using logical connections to one or more remote computers, such as a remote server 24. The remote server 24 may be a personal computer, a server, a router, a network PC, a peer device or other common network node, and may include many if not all of the elements described above relative to computer 70. Networking environments are commonplace in offices, enterprise-wide computer networks, intranets and the Internet. For example, in the subject matter of the present application, computer 70 may comprise the source machine from which data is being migrated, and the remote computer may comprise the destination machine. Note, however, that source and destination machines need not be connected by a network or any other means, but instead, data may be migrated via any media capable of being written by the source platform and read by the destination platform or platforms. When used in a LAN or WLAN networking environment, computer 70 is connected to the LAN through a network interface 98 or an adapter. When used in a WAN networking environment, computer 70 typically includes a modem or other means for establishing communications over the WAN, such as radio 100, to environments such as the Internet. It will be appreciated that other means of establishing a communications link between computer 70 and other computers may be used.

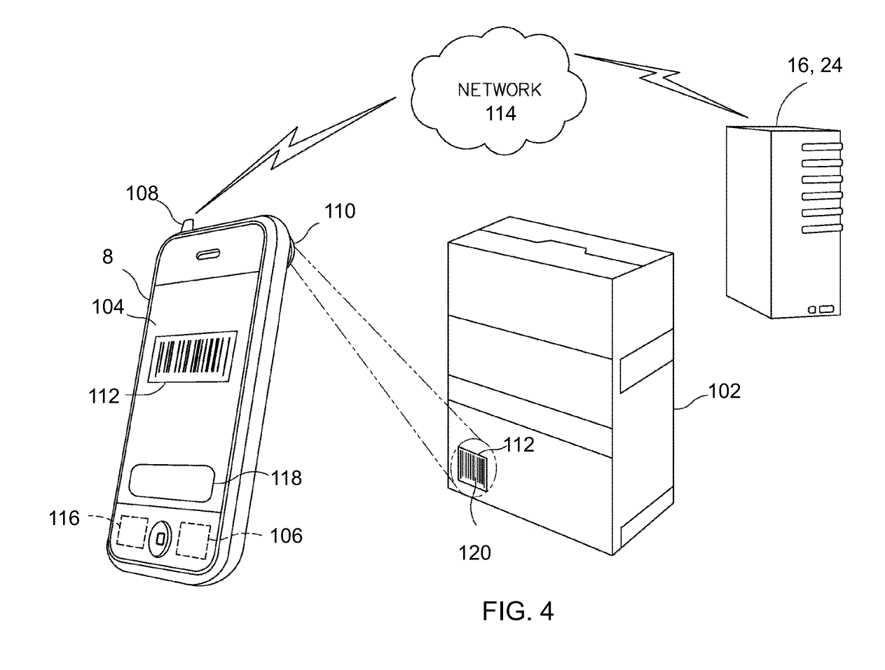

With reference to FIG. 4, illustrated is an exemplary representation of a mobile device 28 for purchasing an item 102 from a retailer at a retail establishment. Mobile device 8 includes any portable electronic device having a processor 106 for executing applications and a display 104 for displaying information connected with the processor 106, and includes such devices as a personal desktop assistant (PDA), a portable computer, a mobile telephone, a smartphone, a netbook, and a tablet computer. Display 104 can use any of a variety of types of display technologies, such as a liquid crystal display (LCD), a cathode-ray tube type display, an electronic ink display, a light emitting diode (LED) type display such as an OLED display, and a plasma display. Preferably, the mobile device 8 also includes a communications device 108 and a scanning module 110. The communications device 108 is connected with the processor 106 and capable of sending and receiving information between one or more other computers connected with the mobile device 8. Preferably, communications device 108 is capable of wirelessly transmitting signals to another computer, such as computer or remote server 16, 18, 24, using a radio transmitter and a radio receiver connected with an antenna. The scanning module 110 is capable of receiving identification information 112 from an item 102 and converting the identification information 112 into a format that the processor 106 can read, such as digital data. Preferably, Scanning module 110 includes any device which can capture, receive and process optical information, such as a barcode or any image, and includes devices such as a digital scanner, a digital camera, a video camera, a barcode reader, and any other type of digital or analog imaging device.

Preferably, communications device 108 communicates with another computer 70, such as remote server 16, 18, 24, via a network 114 using a network interface 116. Network interface 116 is connected with processor 106 and communications device 108, and preferably disposed within remote device 8.

Network 114 may include any type of network that is capable of sending and receiving communication signals, including signals for multimedia content, images, data and streaming video. Network 114 may include a data network, such as the Internet, an intranet, a local area network (LAN), a wide area network (WAN), a cable network, and other like systems that are capable of transmitting information, such as digital data, and the like. Network 114 may also include a telecommunications network, such as a local telephone network, long distance telephone network, cellular telephone network, satellite communications network, cable television network and other like communications systems that interact with computer systems to enable transmission of information between mobile device 8 and another computer such as remote server 16, 18, 24. Network 114 may include more than one network and may include a plurality of different types of networks. Thus, network 114 may include a plurality of data networks, a plurality of telecommunications networks, cable systems, satellite systems and/or a combination of data and telecommunications networks and other like communication systems.

Network 114 is connected with both mobile device 8 and remote server 16, 18, 24 and allows for information to be transmitted and shared between mobile device 8 and remote server 16, 18, 24. Remote server 16, 18, 24 includes any type of computer which can receive, store, process, and transmit information to another computer and includes devices such as a server based computer system capable of interacting with one or more other computer systems.

In one embodiment, mobile device 28 includes location information processing means which allows the mobile device 8 to determine its location. Location information processing means includes devices such a Global Positioning System (GPS) based device, and methods such as using radio triangulation to determine the location of the mobile device 28. Preferably, mobile device 8 includes input means 118 for entering information from a user into the mobile device 28. Input means includes any device which can assist a user to enter information, such as a keyboard, a mouse, a touchpad, a touchscreen, a joystick, a button, and a dial.

Item 102 includes any item or service which is being sold by a retailer. Preferably, the item 102 is located with a retail establishment or store. Item 102 includes item identification information 112 which is any information on the item 102 which assists in identifying the item 102, such as a barcode 120, a serial number, a name of the item 102, and any text, characters, illustrations, or images on the item 102 which can be used to identify the item 102.

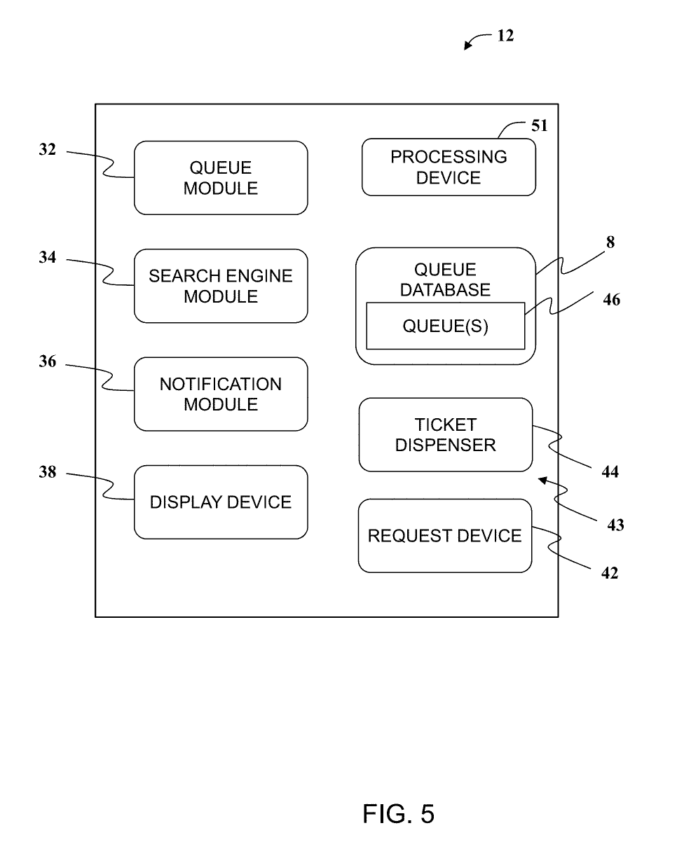

With reference to FIG. 5, a block diagram of an exemplary queue system 12 is displayed. It should be noted that the queue system 12 may be a standalone system or may be integrated in a distributed system that implements, e.g., a sale computer system 22. The queue system 12 may be implemented, at least in part, by the processing unit 51 and the queue database 8. One of more queues or lists of customers is stored within the queue database 8 and managed by the queue system 12. The queue system 12 may further include a communication module 32, a search engine module 34, a notification module 36, a display device 38, a queue placement module 40 and a ticket dispenser 42.

The queue database include at least one queue or list of customers 46. Each list of customers or queue provide a priority for access to a resource. The resource can be any type of resource available at the retail environment 6. For instance, the resource may be one of the following, but not limited to, the pharmacy, the delicatessen, or at a service station, such as customer service or at an auto repair or service facility. Other resources that may experience long lines include customer lines to purchase an on-sale item such as on a special sale day or during specific hours, e.g., Black Friday.

In one embodiment of the present invention, the customer control unit 26, associated with a customer, allows access to the queue or list via the queue system 12. In other words, the customer may request access to, i.e., to be added to a specific queue or list in order to be allowed access to the associated resource.

The customer control unit 26 is configured to receive a request from the customer to be added to the queue and to generate a request signal. The customer control unit 26 may communicate to the queue system 12 through a cellular data network or through the wireless communications unit 25.

In one aspect of the present invention, the customer control unit 26 has access to the queue system 12 only when the mobile device 28 is located within the general vicinity of the relation environment. In other words, the customer must be within, or nearby, the store in order for the customer to access the queue or list. The position of the mobile device 28 may be determined through the GPS unit of the mobile device 28, or as indicated by the cell tower with which the mobile device 28 is communicating, or the wireless communications unit 25 with which the mobile device 28 is communication, or some other method.

If the customer control unit 26 is located in or nearby the retail environment 6, the customer is permitted to access the queue system 12. For example, if in range, the customer may use the customer control device 26 to request to be added to the list or queue. Additionally, the customer control device 26 may be utilized to display or play messages (text, images, and/or audio) based on the customer's position on the list. In one aspect of the present invention, the queue or list is a first in, first out (FIFO) list. In other words, the first customer added to the list is the first customer called or removed from the list (and given access to the resource).

The queue module 32 configured to receive the request signal, to assign the customer a number in the queue, and to store the queue number assigned to the customer at the bottom of the list in the database 46.

In one embodiment, each list or queue 46 has a predefined series of numbers, e.g., 1-100. Generally, the numbers are assigned to customer in order. For instance, a first customer is assigned #1, a second customer is assigned #2, and so forth. When the resource is available, the next customer is pulled off of the list and provided with service. In general, the customers are pulled from the list or queue 46 in the same order. Thus, the first customer is the first customer pulled from the list 46 and the second customer is the second customer pulled from the list 46.

The request device 42 is configured to receive an input and to generate a search engine request for a first customer in the queue 46. In one embodiment, the request device 42 may include a physical button, a button on a keyboard, or virtual button on a touchscreen device (not shown) that may be operated by a user to indicate that the resource is available. In other embodiments, if access to the resource is automated, the request device 42 may receive a signal from the resource indicating that the resource is available.

The search engine module 34 is coupled to the database 8 and being configured to receive the search engine request, to access the database, to establish the first customer from the list of customers as a function of the search engine request, and to return the queue number associated with the next customer.

The notification module 36 is coupled to the search engine module and the customer control unit and is configured to receive the queue number associated with the next customer and to send a message to the customer control unit 26 to inform the customer of a relative position in the queue 46.

For instance, the customer control unit 26 may be configured to receive and display a message that is indicative of the customer's approximate wait time. Alternatively and/or in addition, the customer control unit 26 may be sent and display a message indicative of the customer's place in line, e.g., #5 or #1.

In another aspect of the present invention, the queue system 12 includes a physical queue ticket system 43 coupled to the queue module. The queue module being configured to receive a request from the physical queue ticket system 43 for a position on the list of customers from an anonymous customer. In one embodiment of the present invention, the physical queue ticket system 43 includes a ticket dispenser 44. The queue module 32 assigns a next queue number to the anonymous customer. In one embodiment, the queue module 32 assigns the next queue number to the anonymous customer and sends the next queue number to the ticket dispenser 44. The ticket dispenser 44 may include a printer (not shown) configured to print the assigned queue number on a paper ticket and dispense the ticket to the anonymous customer.

In another embodiment, the ticket dispenser 44 dispenses (pre)-printed tickets. The pre-printed tickets have a predetermined series of tickets, e.g., T1-T100. The series of queue numbers and the pre-printed tickets are placed within the queue 46 based on the time at which the queue and/or ticket numbers are assigned to customers. Thus, the list or queue 46 would or could consist of a mix of (virtual) queue numbers and physical ticket numbers.

In another embodiment of the present invention, the system 12 further includes a display device 38 coupled to the search engine module 34. The search engine module 34 is configured to send the queue number associated with the first customer from the list of customers to the display device 38. If the first customer from the list of customers is the anonymous customer, the display device being configured to display the queue number associated with the anonymous customer. The queue number for customers who requested a place in the queue 46 utilizing the customer control module 26 may also be displayed on the display device 46.

In another embodiment, the queue number(s) of the customers currently being served and the next predetermined number of customers in the queue 46 may be listed or shown on the display device 38. The display device 38 may be located relative to the associated resource to maximize the view-ability of the display device 38.

In another aspect of the present invention, the queue system 12 may manage multiple queues 46 associated with different resources. The customer control unit 26 may be configured to display a list of resources or queues to the customer and to allow the customer to select one of the resources to be placed on the respective queue.

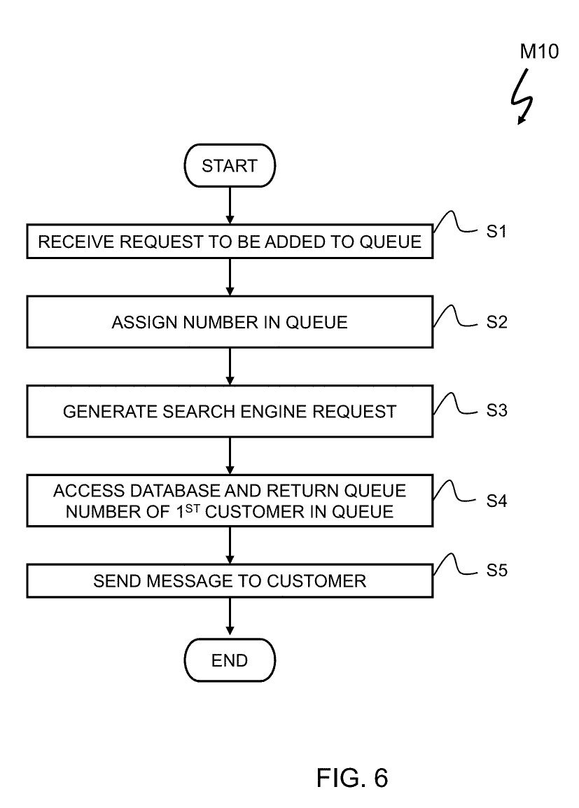

With reference to FIG. 6, in one embodiment of the present invention, a method M10 for managing a queue for access to a resource if provided. The queue is stored in a database. In a first step S1, a request to add a customer to the queue is received at the customer control unit 26. In a second step the request is received at a queue module 32 and a queue number is assigned. The queue numbers is stored within the queue.

In a third step S3, in response to a request for the next customer from the queue, a search engine request is generated. In a fourth step S4, the queue database 8 is accessed and the queue number of the first customer within the queue is returned. In a fifth step S5, the customer associated with the selected queue number is notified.

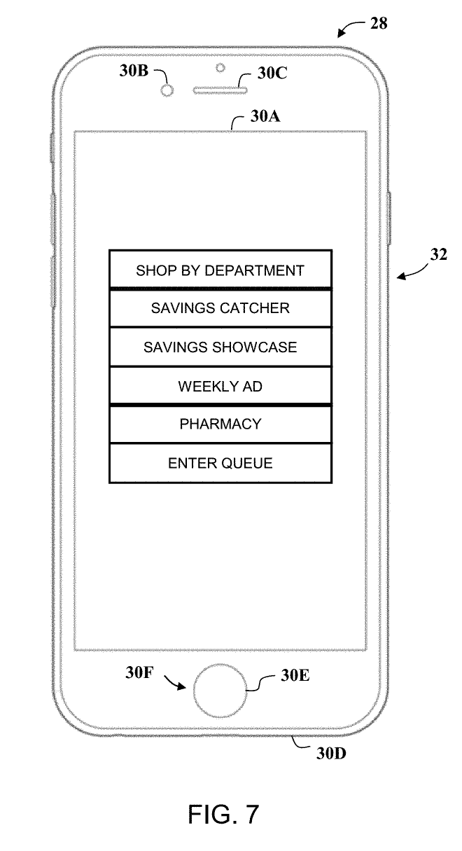

In one embodiment, the user computing device includes a mobile computing device 28 (shown in FIG. 7) such as, for example, a smartphone such as an iPhone™. The mobile computing device 28 includes a processor coupled to a memory device, and a database for storing various programs and data for use in operating the mobile computing device 28 (see above). The mobile computing device 28 may also include a touchscreen display device 30A, one or more video image cameras 30B, one or more speakers 30C, a microphone 30D, at least one input button 30E, and one or more sensors 30F including, but not limited to, a touch ID fingerprint sensor coupled to an input button 30E, a barometer, a three-axis gyro, an accelerometer, proximity sensor, and an ambient light sensor. In addition, the mobile computing device 28 may also include a Wi-Fi antenna, a cellular network antenna, a Bluetooth™ communications device, assisted GPS and GLONASS, a digital compass, and an iBeacon microlocation device.

In the illustrated embodiment, the mobile computing device 28 has stored thereon and executes the customer control unit 26. The customer control unit 26 may be downloaded from an app store or other source.

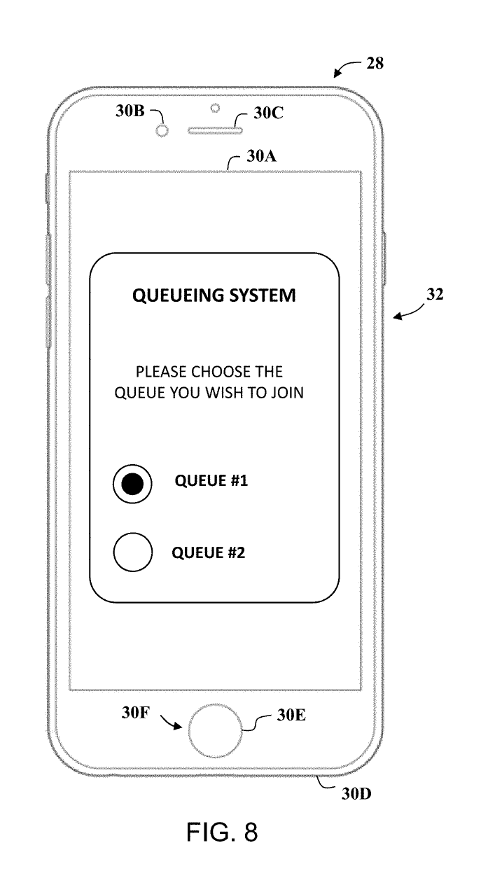

With reference to FIG. 7, the customer control unit 26 may provide access to the one or more functions available while in the retail environment 6. Some of the functions may be available outside of the retail environment 6. As shown, the customer control unit 26 may present a user interface 32 to the customer. In FIG. 7, the user interface 32 displays to the customer the functions or operations currently available. If the customer selects the “Enter Queue” option, then a list of the queues available currently available are shown (see FIG. 8).

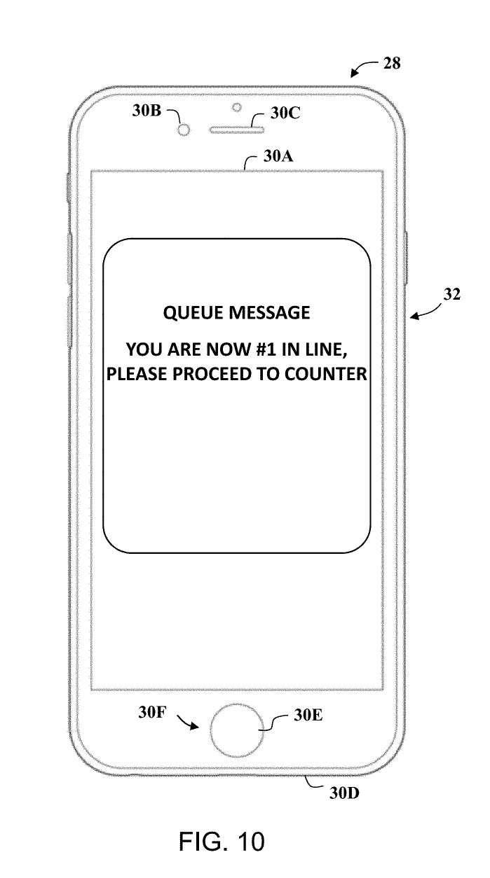

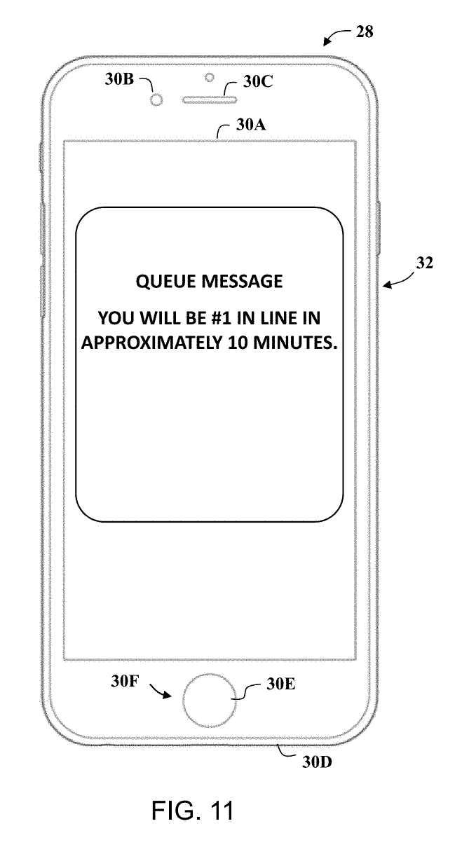

Once the customer selects a queue to join, the customer may be informed, through a message displayed on the customer control unit 26. In the exemplary message of FIG. 8, the customer may be informed of their current position in the queue. In the exemplary message of FIG. 10, the customer is informed that the customer has reached the front or top of the queue and that the customer should now proceed directly to the resource. Additionally, the customer may be informed of approximate current wait time (see FIG. 11).

A controller, computing device, server or computer, such as described herein, includes at least one or more processors or processing units and a system memory (see above). The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention.

What is claimed is:

1. A system, comprising:
a database including a list of customers, the list of customer defining a queue for access to a resource;
a customer control unit associated with a customer, the customer control unit being configured to receive a request from the customer to be added to the queue and to generate a request signal;
a queue module configured to receive the request signal, to assign the customer a number in the queue, and to store the queue number assigned to the customer at the bottom of the list in the database;
a request device configured to receive input and to generate a search engine request for a first customer in the queue;
a search engine module coupled to the database and the request device and being configured to receive the search engine request, to access the database, to establish the first customer from the list of customers as a function of the search engine request, and to return the queue number associated with the next customer; and,
a notification module coupled to the search engine module and the customer control unit and being configured to receive the queue number associated with the next customer and to send a message to the customer control unit to inform the customer of a relative position in the queue.

2. A system, as set forth in claim 1, wherein the customer control unit is executed on a mobile device associated with the customer.

3. A system, as set forth in claim 1, wherein the resource in located within a retail environment.

4. A system, as set forth in claim 3, wherein the customer control unit must be located within the retail environment for the customer to be added to the queue.

5. A system, as set forth in claim 4, wherein the customer control unit must be located within the retail environment for the customer control unit to receive the message.

6. A system, as set forth in claim 1, further comprising a physical queue ticket system coupled to the queue module and the search engine module, the request module being configured to receive a request for a position on the list of customers from an anonymous customer.

7. A system, as set forth in claim 6, wherein the physical queue ticket system includes a ticket dispenser, the queue module being further configured to assign a next queue number to the anonymous customer and to communicate the next queue number to the ticket dispenser, the ticket dispenser configured to dispense a ticket having the next queue number.

8. A system, as set forth in claim 6, further comprising a display device coupled to the search engine module, the search engine module being configured to send the queue number associated with the first customer from the list of customers to the display device, if the first customer from the list of customers is the anonymous customer, the display device being configured to display the queue number associated with the anonymous customer.

9. A system, as set forth in claim 1, wherein the database is configured to store multiple lists of customers, each list being associated with a different resource.

10. A system, as set forth in claim 9, wherein the control unit is configured to display a list of resources to the customer and to allow the customer to select one of the resources to be placed on the respective queue.

11. A system, as set forth in claim 1, wherein the resource is one of a check-out line, a pharmacy line, a deli line, a line for purchase of a sale item, and a service resource.

12. A system, as set forth in claim 1, wherein the message to the customer control unit indicates an estimated time until the customer is the first customer in the queue.

13. A method, including the steps of:
maintaining a database including a list of customers, the list of customers defining a queue for access to a resource;
receiving a request, at a customer control unit associated with a customer, to add the customer to the queue, and generating a request signal;
receiving the request signal, at a queue module, assigning the customer a number in the queue, and storing the queue number assigned to the customer at the bottom of the list in the database;
receiving an input at a request device and generating a search engine request for a first customer in the queue;
receiving the search engine request, at a search engine module coupled to the database and the input device, accessing the database to establish the first customer from the list of customers as a function of the search engine request, and returning the queue number associated with the next customer; and,
receiving the queue number at a notification module coupled to the search engine module and the customer control unit and responsively sending a message to the customer control unit to inform the customer of a relative position in the queue.

14. A method, as set forth in claim 13, wherein the customer control unit is executed on a mobile device associated with the customer.

15. A method, as set forth in claim 13, wherein the resource in located within a retail environment.

16. A method, as set forth in claim 15, wherein the customer control unit must be located within the retail environment for the customer to be added to the queue.

17. A method, as set forth in claim 15, wherein the customer control unit must be located within the retail environment for the customer control unit to receive the message.

18. A method, as set forth in claim 13, including the step of receiving a request, at a physical queue ticket system, for a position on the list of customers from an anonymous customer.

19. A method, as set forth in claim 18, including the steps of:
assigning a next queue number to the anonymous customer;
communicating the next queue number to a ticket dispenser; and,
dispensing, by the ticket dispenser, a ticket having the next queue number.

20. A method, as set forth in claim 18, including the steps of sending the queue number associated with the first customer from the list of customers to a display device, if the first customer from the list of customers is the anonymous customer, and displaying the queue number associated with the first customer from the list of customer on the display device.

21. A method, as set forth in claim 13, wherein the database is configured to store multiple lists of customers, each list being associated with a different resource.

22. A method, as set forth in claim 21, including the steps of displaying on the customer control unit a list of resources to the customer and allowing the customer to select one of the resources to be placed on the respective queue.

23. A method, as set forth in claim 13, wherein the resource is one of a check-out line, a pharmacy line, a deli line, a line for purchase of a sale item, and a service resource.

24. A method, as set forth in claim 13, wherein the message to the customer control unit indicates an estimated time until the customer is the first customer in the queue.

25. One or more non-transitory computer-readable storage media, having computer-executable instructions embodied thereon, wherein when executed by at least one processor, the computer-executable instructions cause the processor to:
maintain a database including a list of customers, the list of customers defining a queue for access to a resource;
receive a request, at a customer control unit associated with a customer, to add the customer to the queue, and generating a request signal;
receive the request signal, at a queue module, assign the customer a number in the queue, and store the queue number assigned to the customer at the bottom of the list in the database;
receive an input at a request device and generate a search engine request for a first customer in the queue;
receive the search engine request, at a search engine module coupled to the database and the input device, access the database to establish the first customer from the list of customers as a function of the search engine request, and return the queue number associated with the next customer; and,
receive the queue number at a notification module coupled to the search engine module and the customer control unit and responsively send a message to the customer control unit to inform the customer of a relative position in the queue.
